(19) United States
(12) Patent Application Publication
(10) Pub. No.: US 2013/0223959 A1
(43) Pub. Date: Aug. 29, 2013

(54) PICKING METHOD AND SYSTEM

(71) Applicant: Roland Koholka, Lannach (AT)

(72) Inventor: Roland Koholka, Lannach (AT)

(73) Assignee: Knapp AG, Hart bei Graz (AT)

(21) Appl. No.: 13/882,545

(22) PCT Filed: Nov. 14, 2011
(86) PCT No.: PCT/EP11/70003

§ 371 Date: Apr. 30, 2013

(30) Foreign Application Priority Data
Nov. 24, 2010 (AT) A 1954/2010

(51) Int. Cl. B65G 1/137

(52) U.S. Cl. CPC B65G 1/137
USPC 414/267; 414/807

(57) ABSTRACT

During picking products (P) stored in high-bay racking (R), the products are transported to manual goods-to-person picking stations (M1-M8) by means of a conveyor system (2). Order transport units (B) can be supplied to the goods-to-person picking stations (M1-M8), into which order transport units products supplied to the goods-to-person picking stations (M1-M8) are picked manually according to picking orders. All products (P) of the high-bay racking (R) which are to be picked manually can be supplied to all goods-to-person picking stations (M1-M8). If a picking order includes products (P) to be picked manually, at least one order transport unit (B) is allocated to those products to be picked manually, wherein each order transport unit is supplied to only one manual goods-to-person picking station (M1-M8) at which all products to be picked manually which have been allocated to this order transport unit are picked. The respective order transport unit (B) is transported to the manual goods-to-person picking station (M1-M8) only when said picking station is ready to be filled with products (P) according to a picking order.

The invention relates to a method and a system for picking products stored in high-bay racking.

In traditional storages, different picking stations are passed through sequentially by an order container and, in each picking station that has been approached, products according to the order allocated to the order container are delivered in the stipulated number of pieces. The individual picking stations are, in each case, optimized toward a certain product range. The main optimization criteria are the frequency of the accesses to a product and the product properties (e.g., automatable or not, etc.).

Products which are required often and, in technical language, are referred to as “fast moving” and are also automatable are picked in automatic picking systems such as, e.g., central belt autopickers. For other products, semi-automatic or manual picking stations are used. A manual station can be operated as per the principle “goods-to-person” or “person-to-goods”.

The size of a station (number of product types to be picked) depends on the required picking throughput. Especially in manual picking stations as per the “person-to-goods” principle, the achievable picking throughput depends directly on the number of product types in the picking station.

Thus, it is typical that several manual picking stations are required in the storage for generating the necessary throughputs. All product types which cannot be processed in automatic picking systems are picked via said manual picking stations, with different products being allocated to each picking station. Overlaps in the product portfolio at the picking stations are indeed possible, but atypical. A typical procedure in a traditional storage is that, after the start of the order, an order container passes consecutively through a number of automatic picking systems and manual picking stations in order to handle the picking order. After the complete settling of the picking order, the order container reaches a shipping area.

A disadvantage of manual picking stations in traditional storages is that the processing time of an order is substantially longer than with automatic systems. In addition, the processing time depends on the personal job performance of an employee and is thus not deterministic. In order to compensate for fluctuations in the job performances of employees, for each manual picking station, a buffer is necessary in which orders which have begun to be processed, i.e., order containers, can be stored temporarily. Only in this way is it possible to make sure that, on the one hand, the employee at the manual picking station is permanently supplied with work (orders) and, on the other hand, the connecting conveyor between the picking stations is not blocked by a pile-up of order containers from a manual picking station. Especially the blocking of the connecting conveyor is very disadvantageous since the flow of the order containers through the storage is blocked and, hence, several picking stations are unable to receive and, respectively, release the order containers as requested. For this reason, the buffers at the manual stations must be dimensioned sufficiently large, which means that enough space has to be created for those buffers in the storage and a conveyor must exist which has been dimensioned appropriately large. This is cost- and space-consuming. In order to be able to avoid the installation of large buffers, it has been suggested in DE 101 36 354 A1 that each order container is returned to a container shelf after its partial picking at a manual picking station to be conveyed from there via the conveyor to a subsequent manual picking station, if said subsequent picking station is ready for work.

A further disadvantage of the non-deterministic processing time at manual picking stations is that no exact data can be given for the estimated total processing time of an order. Estimations regarding the total processing time must always be based on a conservative assumption in order to prevent the occurrence of standstill times during shipping, since order containers take considerably longer for passing through the storage than what has been estimated.

Basically, it is true that, with manual picking stations as per the “person-to-goods” principle, the fluctuation in the throughput rate is higher than with manual picking stations as per the principle “goods-to-person”. The reason for this are the longer processing times per product type at “person-to-goods” picking stations which are due to the necessary distances covered by an employee when he or she has to proceed to the storage location of the products.

Therefore, there is still a need for a picking method and a picking plant whereby the fluctuation in the throughput rate during the processing of picking orders can be reduced in contrast to the prior art and the throughput time of order containers through the storage can generally be minimized. Furthermore, the necessary buffer sections and hence the required conveyor are to be minimized. In addition, an improved deterministic processing time at manual picking stations should be achieved, which allows to drastically reduce the number of buffer places for order transport units, which so far had to be provided in front of manual picking stations.

These objects are achieved by a method of picking products stored in high-bay racking according to the features of claim 1 as well as by a picking system for products stored in high-bay racking according to the features of claim 8. Advantageous embodiments of the invention are presented in the sub-claims and exemplary embodiments.

The method according to the invention of picking products stored in high-bay racking serves for operating a high-bay racking to which a storage transport system for storing the products and retrieving them from storage and for transferring products retrieved from storage to a conveyor system are allocated, wherein products retrieved from storage with the conveyor system can be transported to one or several, preferably at least two, manual goods-to-person picking stations. To the goods-to-person picking stations, order transport units, such as, e.g., order containers, trays, pallets etc., can be supplied into which products supplied to the goods-to-person picking stations are picked manually according to picking orders and in the number of pieces specified in the picking orders. As per the method according to the invention, all products of the high-bay racking which are to be picked manually can be supplied to all goods-to-person picking stations. If a picking order includes products to be picked manually, at least one order transport unit is allocated to those products to be picked manually, wherein each order transport unit is supplied to only one manual goods-to-person picking station at which all products to be picked manually which have been allocated to this order transport unit are picked manually in the stipulated number of pieces. The respective order transport unit is transported to the manual goods-to-person picking station only when said picking station is ready to be filled with products according to a picking order.

The picking system according to the invention for products stored in high-bay racking comprises:

a storage transport system for retrieving the products from the high-bay racking and, respectively, storing them in the high-bay racking;

a conveyor system onto which products taken out of store and onto the storage transport system can be transferred;

one or several, preferably at least two, manual goods-to-person picking stations to which products retrieved from storage can be transported by the conveyor system;

a conveyor system by means of which order transport units, such as, e.g., order containers, trays, pallets, can be supplied to the goods-to-person picking stations and can be transported from the goods-to-person picking stations to a subsequent processing station, such as a shipping area or a temporary storage facility;

wherein products supplied to the goods-to-person picking stations can be picked manually according to picking orders and in the number of pieces specified in the picking orders; wherein all products of the high-bay racking which are to be picked manually can be supplied to all goods-to-person picking stations via the conveyor system; and

a control is provided which, if a picking order includes products to be picked manually, allocates at least one order transport unit to those products to be picked manually and controls the conveyor system such that each order transport unit is supplied to only one manual goods-to-person picking station at which all products to be picked manually which have been allocated to this order transport unit are picked manually in the stipulated number of pieces, wherein the respective order transport unit is transported to the manual goods-to-person picking station only when said picking station is ready to settle a picking order.

The major advantage of the picking method and system according to the invention over the prior art is that, in the course of processing picking orders, an order transport unit only has to make a stop at a manual goods-to-person picking station where it is filled directly or indirectly with products of said picking order which are to be picked manually, so that an approximately deterministic throughput time of the order transport unit through the picking system can be achieved. Due to the approximately deterministic throughput time of the order transport unit through the picking system, a substantially shorter order processing time can altogether be achieved.

It should be mentioned that the terms “transport system” and “conveyor system”, respectively, as used herein, include, besides classical conveyor technique, also shuttles or freely movable robots.

Furthermore, it should be mentioned that the term “manual goods-to-person picking station” can be understood such that physical persons (pickers) can be replaced by robots which are able to snatch products from a product container and transfer them into the order transport unit or a buffer container. Such robots simulate human action, but differ fundamentally from automatic or semi-automatic picking stations which, in literature, are sometimes also referred to as picking robots.

If at least two manual goods-to-person picking stations are provided to which products retrieved from storage can be transported by the conveyor system, a uniform distribution of the job load of products to be picked manually can be achieved.

Manual goods-to-person picking stations can be constructed such that supplied products can be transferred manually directly into the order transport unit. Alternatively or additionally thereto, manual goods-to-person picking stations can be equipped with buffer containers, particularly buffer bowls, into which products to be picked are transferred manually, before an order transport unit allocated to those products is transported to the picking station, wherein the buffer containers are emptied out onto a central belt which discharges the products into the order transport unit downstream at a transfer station. As an alternative, the buffer containers are emptied out directly into the order transport unit. An advantage of picking into buffer containers is that the person performing the picking may already work on a picking order before the order transport unit has been brought close and, respectively, may work on several picking orders in parallel.

Advantageously, at the manual goods-to-person picking station, equal products which are included in several picking orders are picked into different buffer bowls allocated to the different picking orders in a parallel processing of the picking orders. In this way, the advantage is achieved that the products do not have to be delivered to the goods-to-person picking stations in the sequence of the orders, which increases the total throughput and reduces the complexity of the control. Furthermore, it is likely that a fast moving product is required for several pending orders and, hence, the content of a source container can be distributed over several orders during only one stop; this reduces the traffic on the transport system. In the case of an error, if a product cannot be retrieved from storage and transported to the manual picking station, the person performing the picking can work on other orders or pick other products of a picking order so that he or she does not have to put up with waiting times.

A sequential passage of the order transport units is achievable if each order transport unit, before or after it is filled at the manual goods-to-person picking station allocated to it with the products of a picking order which are to be picked manually, is transported to at least one automated picking system, where it is filled with products of the picking order allocated to it which can be picked automatically or semi-automatically, and/or is transported to a transfer area of a central belt, where the order transport unit is filled with products located on a belt section allocated to said picking order, which products have upstream been picked automatically or semi-automatically onto the belt section. It is preferred that the sequential passage of the order transport units begins with manual picking. Optionally, however, the order transport units can at first be transported to automated picking systems, where they receive products which can be picked automatically; subsequently, the partially filled order transport units are forwarded to the respective manual picking station which has been allocated and are manually filled there with products.

In a further embodiment of the invention, a fast access storage attached to the conveyor system is provided, in which fast moving products can be stored temporarily and supplied to the manual goods-to-person picking stations via the conveyor system. A substantially quicker supply of the manual goods-to-person picking stations with fast moving products is achieved with this embodiment than with conventional picking systems. By increasing the throughput in this way by means of the products stored temporarily in the fast access storage, for example, the persons in charge of the storage facility can also be absolved from the task assigned to them in conventional picking systems, namely of obtaining an improvement of the total throughput by smartly selecting storage places for fast moving products in accordance with their professional experience.

If the fast access storage comprises at least one lift on which platforms are arranged on top of each other in several levels, in which products and optionally order transport units can be stored and, respectively, retrieved from storage, the fast access storage requires only a small floor space despite a high storage capacity. If order transport units are also stored temporarily, load peaks during picking can be avoided in that picking orders which have been received only as partial orders are already settled while the job load is small and the products of the partial picking orders are stored temporarily in the order transport units in the fast access storage or optionally in high-bay racking, until the remaining picking order is available, and are then fetched from the temporary storage location for completing the order.

A high throughput of the products and source containers, respectively, and optionally of the order transport units into and from the fast access storage is achieved if the platforms and the lift comprise drive elements, e.g., motor rollers, by means of which products and source containers, respectively, in which the products are placed, and optionally order transport units are moved actively.

The temporary storage capacity can be increased with the throughput remaining the same if the platforms are built with such a depth that at least two products or source containers are accommodated behind each other per platform, wherein preferably a type-sorted storage of products is carried out per platform.

The invention is now illustrated in further detail with reference to the drawings, on the basis of exemplary embodiments. In the drawings

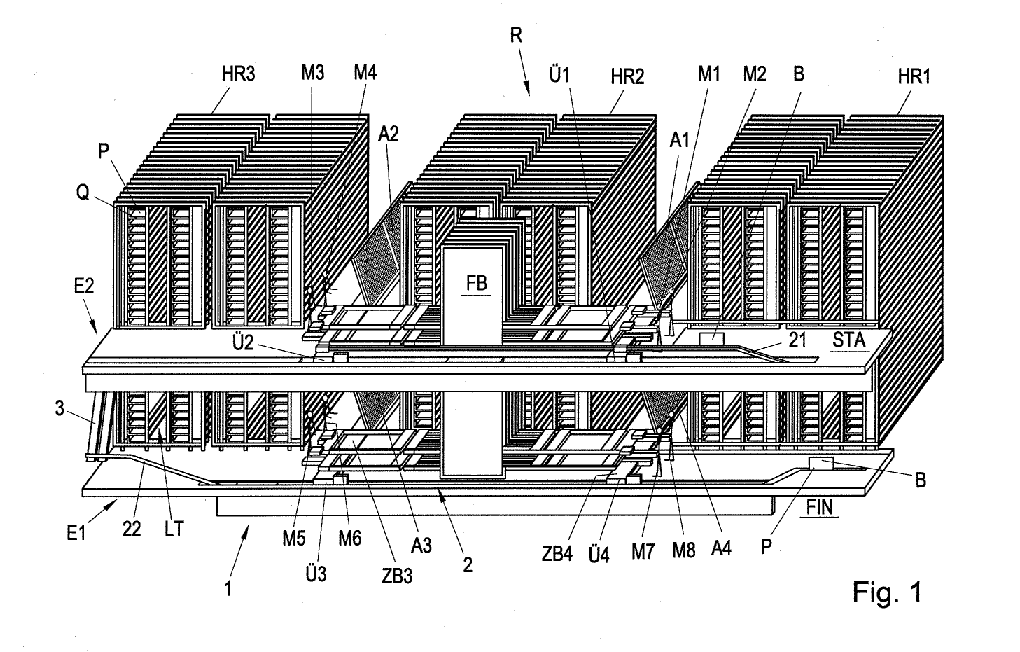

FIG. 1 shows a high-rack storage area comprising a picking system according to the invention in 3D view;

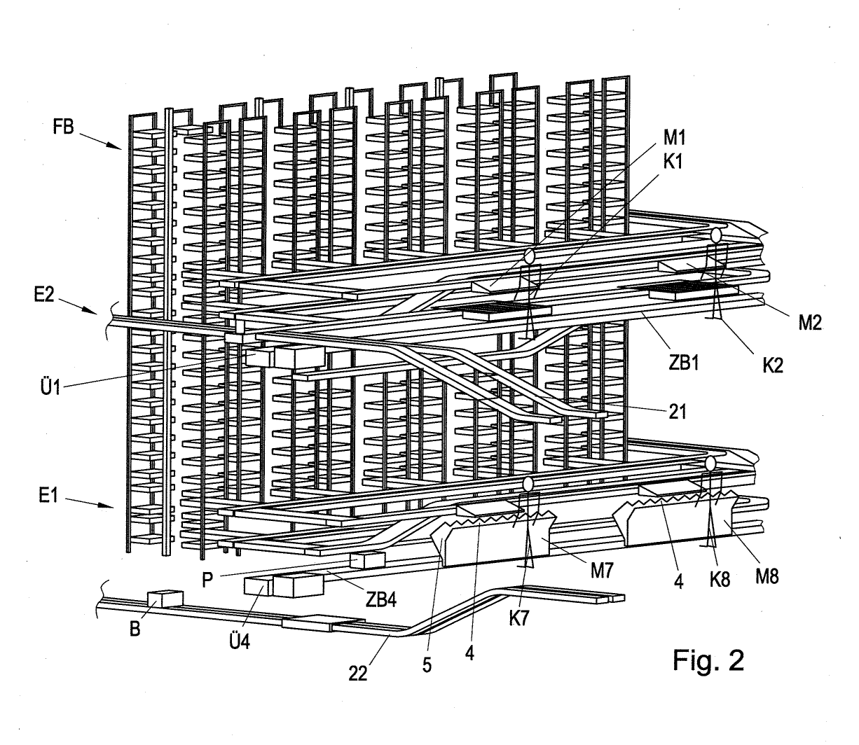

FIG. 2 shows a detail of the high-rack storage area and the picking system of FIG. 1 in 3D view;

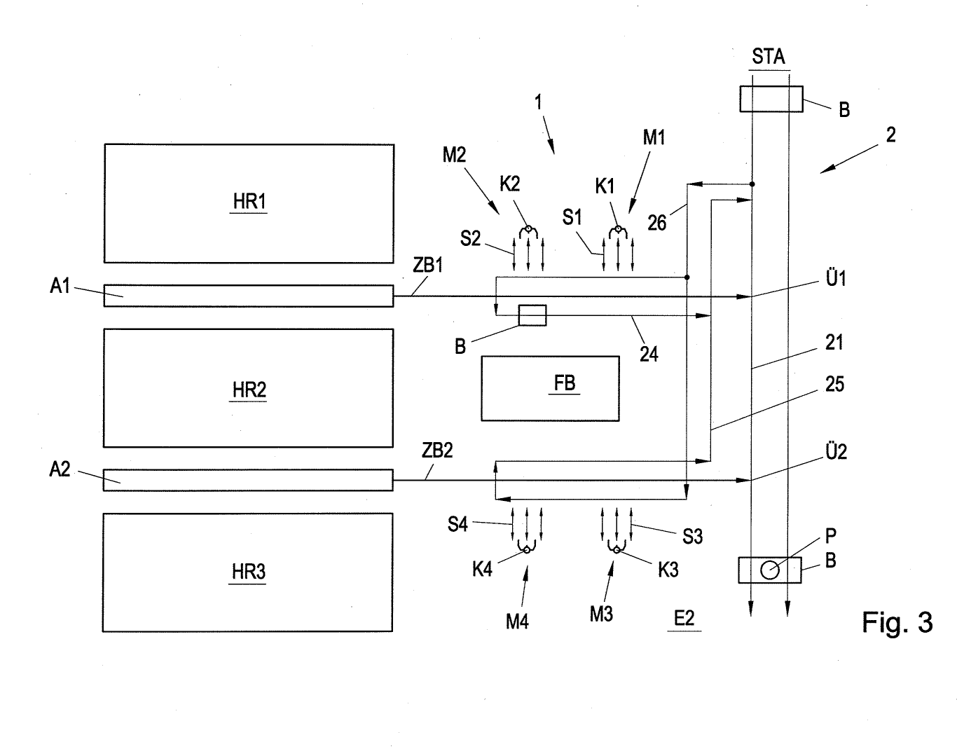

FIG. 3 shows the paths of the order transport units on an upper picking level of the picking system to and from the manual goods-to-person picking stations;

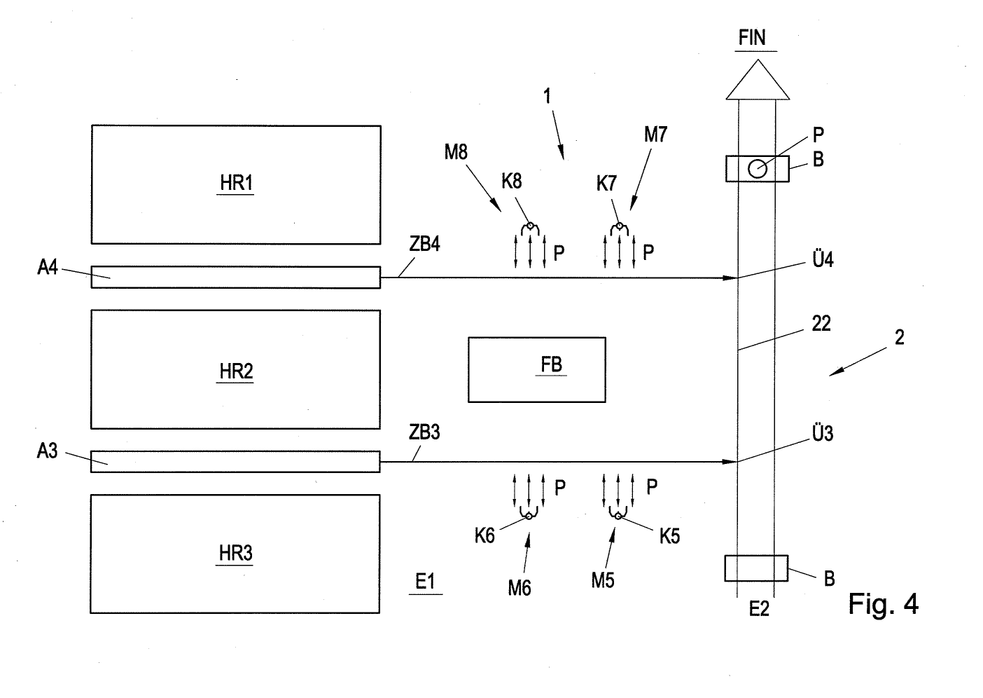

FIG. 4 shows the paths of the order transport units and products on a lower picking level of the picking system;

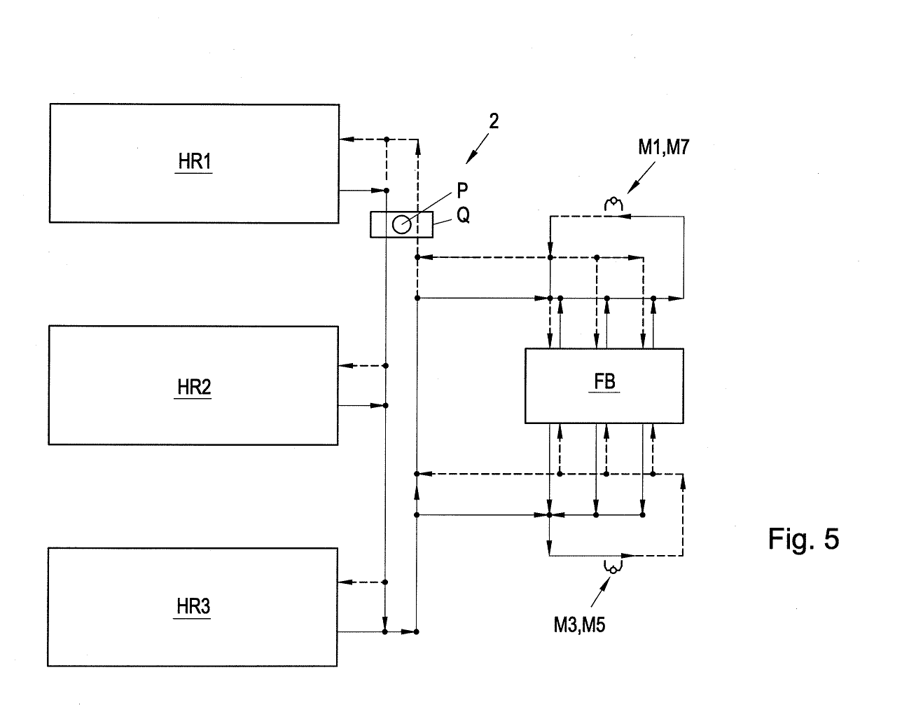

FIG. 5 shows the paths of the products and source containers, respectively, in the picking system when goods are retrieved from the high racks and the fast access storage and taken to the manual goods-to-person picking stations;

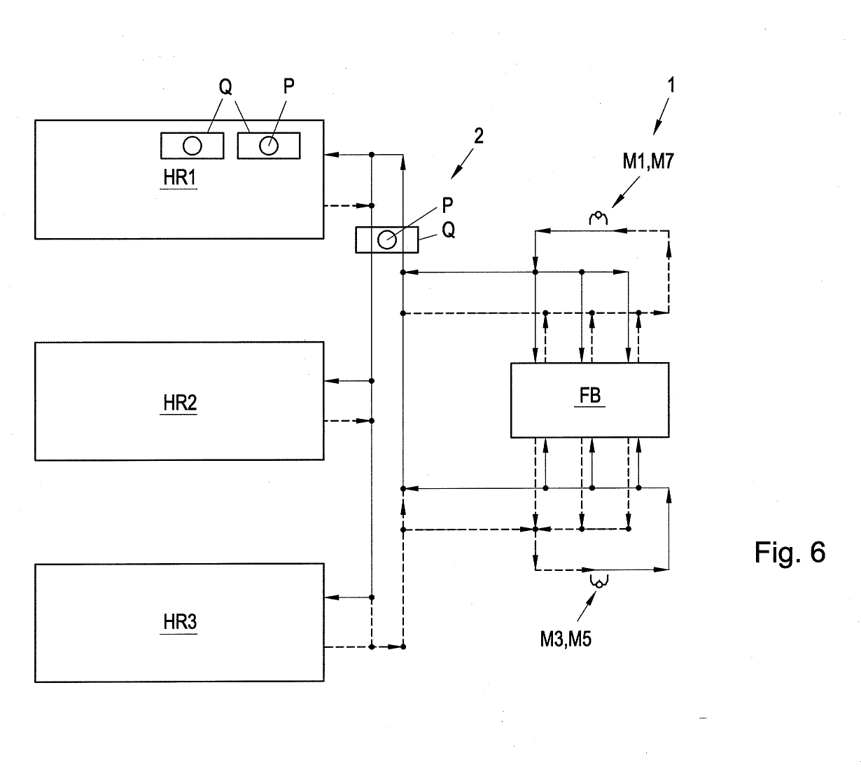

FIG. 6 shows the paths of the products and source containers, respectively, in the picking system when goods are returned from the manual goods-to-person picking stations to the high racks or the fast access storage, respectively;

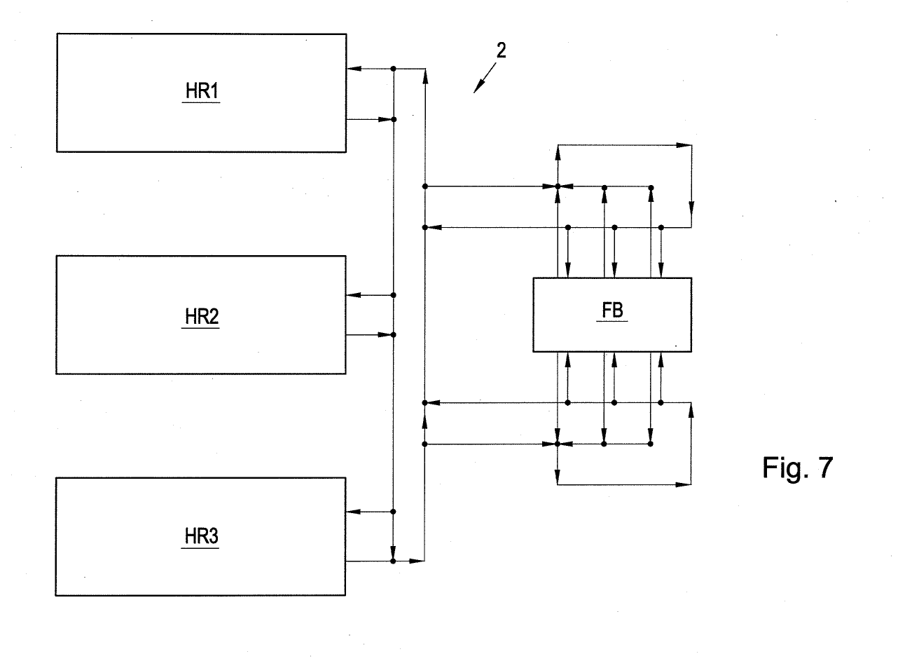

FIG. 7 shows the entire product flow between high racks, the fast access storage and manual goods-to-person picking stations in the picking system; and

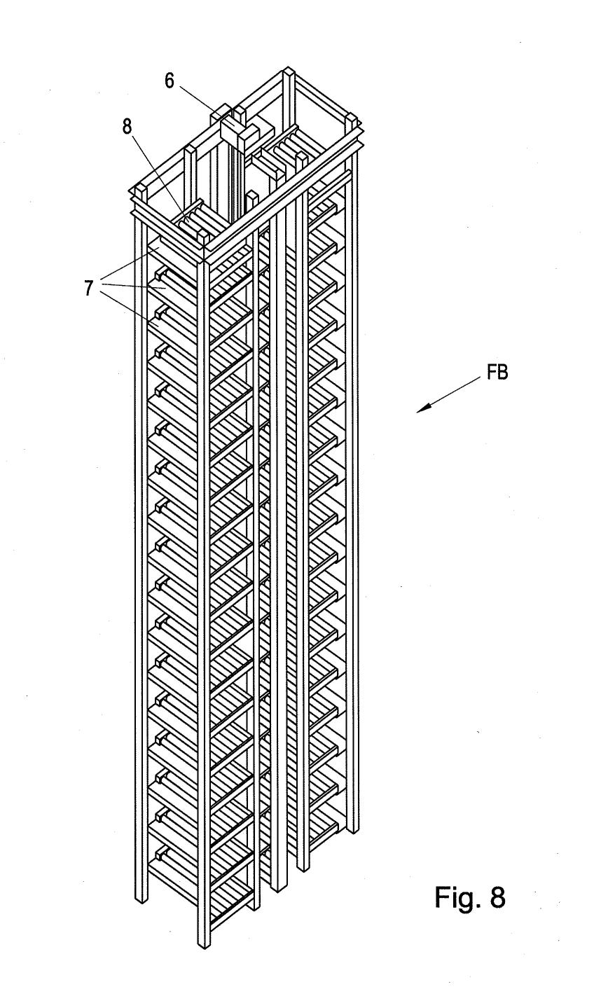

FIG. 8 shows a perspective view of the fast access storage.

FIG. 1 and FIG. 2 show a high-bay racking R designed as a high-rack storage area and comprising a picking system 1 according to the invention. In FIG. 1, three high racks HR1, HR2, HR3 are illustrated, with each high rack comprising a plurality of shelf levels on top of each other and, in turn, a plurality of storage places for products P being provided on each shelf level. The products may either be stored directly in the storage places or may be located in source containers Q, which are stored in the storage places. The advantage of using source containers Q consists in the simplified storing of goods and retrieving them from storage, since the source containers have standardized shapes and sizes. The various products P are delivered to the high-bay racking R in large numbers of pieces by truck or rail and are stored therein by means of a storage transport system. In general, the storage transport system serves for storing products, retrieving them from storage and also returning them to storage and, in the drawing, is generally indicated by an arrow LT. The storage transport system LT may comprise roller transport systems, shelf-operating devices (shuttles), lifts, hauling tracks etc. in a known manner.

The storage transport system LT is connected with a conveyor system 2 which is part of the picking system 1. The storage transport system LT transfers products P which have been retrieved from the shelves to the conveyor system 2, either directly or while being stored in source containers Q, and receives products P from the conveyor system 2 which are to be placed in storage or returned to storage, respectively, either directly or in source containers Q. In addition, the conveyor system 2 transports order transport units B required for the picking order through the picking system 1 from the beginning of the handling of a picking order to its completion. The conveyor system 2 may comprise roller transport systems, lifts, hauling tracks etc. in a known manner and is illustrated in further detail below. The order transport units B may comprise, for example, order containers, trays, pallets etc.

In the illustrated exemplary embodiment, the picking system 1 is arranged on two superimposed picking levels E1, E2 for space-saving reasons, with an upper main hauling track 21 of the conveyor system 2 running on the upper picking level E2 and a lower main hauling track 22 running on the lower picking level E1. The two main hauling tracks 21, 22 are connected via a connecting section 23 which bridges the height difference from the upper picking level E2 to the lower picking level E1.

On the upper picking level E2, four manual goods-to-person picking stations M1, M2, M3, M4 are arranged to which products P retrieved from the shelves HR1, HR2, HR3 can be transported by means of the conveyor system 2, corresponding to the requirement of the picking orders. Furthermore, order transport units B can be supplied to the four manual goods-to-person picking stations M1, M2, M3, M4, which order transport units are supplied from an order starting position STA via the upper main hauling track 21. Said order transport units B are filled with the supplied products P of the respective picking order at the four manual goods-to-person picking stations M1, M2, M3, M4 by persons performing the picking K1, K2, K3, K4 and subsequently transported back to the upper main hauling track 21. The manual goods-to-person picking stations M1-M4 are designed for the direct manual transfer of supplied products P into the order transport units B.

Furthermore, the picking system 1 is equipped with a fast access storage FB attached to the conveyor system 2, wherein “fast moving”, i.e., frequently required products, can be stored temporarily in the fast access storage FB and can be supplied to the manual goods-to-person picking stations M1, M2, M3, M4 via the conveyor system. The advantage of this embodiment is that said fast moving products can be supplied to the manual goods-to-person picking stations M1, M2, M3, M4 considerably faster than if they had to be supplied from the high racks HR1, HR2, HR3.

Furthermore, two automatons A1, A2 are provided on the upper picking level E2, which automatons transfer fast moving products onto central belts ZB1, ZB2, according to picking orders, wherein certain sections of the central belts ZB1, ZB2 are allocated to picking orders by the higher-ranking picking software, which, in a known manner, runs on control computers, which are not illustrated, onto which sections the automatons A1, A2 will then transfer the products allocated to those picking orders in the stipulated number of pieces—which is controlled by the picking software. The central belts ZB1, ZB2 end in transfer stations Ü1, Ü2 arranged at the upper main hauling track 21. The picking software controls the run of the central belts ZB1, ZB2 such that, at the transfer stations Ü1, Ü2, the products transported on certain sections of said belts are transferred in order transport units B allocated to the picking order and transported on the upper main hauling track 21. The order transport units B either may contain products which have partially already been picked manually at the manual goods-to-person picking stations M1-M4 or may still be empty. After the order transport units B have passed the second central belt ZB2, they continue to move along the upper main hauling track 21 as far as to the connecting section 3 and are moved to the lower picking level E1 on said connecting section 3 and transferred onto the lower main hauling track 22. It should be pointed out that the central belts ZB1, ZB2 indeed pass between the manual goods-to-person picking stations M1-M4, but are not operationally related to them.

FIG. 3 schematically shows the possible paths of the order transport units B on the upper picking level E2. Starting from an order starting position STA, the order transport units B are transported on the upper main hauling track 21. From the upper main hauling track 21, a first branch track 26 branches off, on which order transport units B can be discharged from the upper main hauling track 21 and subsequently guided past the manual goods-to-person picking stations M3, M4, where they are discharged by means of sluices S3, S4 into the manual goods-to-person picking stations M3, M4 and, after having been filled with products by the persons performing the picking K3, K4, can be channelled back into the first branch track 26, which comprises a return branch 25 which ends in the upper main hauling track 21 so that the order transport units B transported on the return branch 25 will get back to the upper main hauling track 21 and, on said track, will reach the lower picking level El via the connecting section 3. From the first branch track 26, a second branch track 24 branches off, on which order transport units B can be discharged from the first branch track 26 and subsequently guided past the manual goods-to-person picking stations M1, M2, where they are discharged by means of sluices S1, S2 into the manual goods-to-person picking stations M1, M2 and, after having been filled with products by the persons performing the picking K1, K2, can be channelled back into the second branch track 24 which ends in the return branch 25 of the first branch track 26. In this way, order transport units B, into which products have been picked manually in the first or second manual goods-to-person picking station M1, M2, get back onto the upper main hauling track 21 and from there to the lower picking level E1.

It is to be noted that the return branch 25 ends in the upper main hauling track 21 upstream of the transfer stations Ü1, Ü2. This means that the order transport units B are first filled with products which have been picked manually and only afterwards with products which have been picked automatically by the automated picking systems A1, A2 onto the central belts.

It is an essential feature that each order transport unit B is supplied to only one of four possible manual goods-to-person picking stations M1-M4 in order to achieve a processing time at the manual goods-to-person picking stations M1-M4 which is as deterministic as possible.

It should be mentioned that the order starting position STA may, for example, be a stacking and separating station for order transport units B, but also a discharging station from the conveyor system 2 by means of which order transport units which already contain products from partially processed picking orders and have been stored temporarily in the high racks HR1-HR3 (or optionally also in the fast access storage FB) are returned into a picking cycle in order to process the associated picking order further or completely.

After the order transport units B have reached the lower picking level E1 via the connecting section 3, they are moved on the lower main hauling track 22 as far as to the picking end position FIN.

On the lower picking level E1, four further manual goods-to-person picking stations M5, M6, M7, M8 are arranged. As can be seen best in FIG. 2, those manual goods-to-person picking stations M5-M8 are equipped with buffer containers 4 designed as buffer bowls, in contrast to the upper manual goods-to-person picking stations. The buffer containers 4 comprise means 5 such as flaps, chutes etc. for emptying products from the buffer containers 4 onto an associated central belt ZB3, ZB4. In this exemplary embodiment, a central belt ZB3 is allocated to the manual goods-to-person picking stations M5, M6, and a different central belt ZB4 is allocated to the manual goods-to-person picking stations M7, M8. The two central belts ZB3, ZB4 end in transfer stations Ü3, Ü4 located on the lower main hauling track 22, wherein, at the transfer stations Ü3, Ü4, products located on sections of the central belts ZB3, ZB4 are transferred in order transport units B according to picking orders, with the order transport units being allocated to those picking orders. The procedure at the four lower manual goods-to-person picking stations M5-M8 is such that products P retrieved from the shelves HR1, HR2, HR3 are supplied to the manual goods-to-person picking stations M5-M8 by means of the conveyor system 2, corresponding to the requirement of picking orders, and persons performing the picking K5, K6, K7, K8 pick the products manually into the buffer containers 4 of their respective manual goods-to-person picking station M5-M8. When the products P of a picking order which are to be picked manually have been picked into the buffer containers 4 and the picking software has allocated a section of the central belt to said picking order, the products are transferred onto this section as it moves past the manual goods-to-person picking station M5-M8. Due to the plurality of buffer containers 4 in each manual goods-to-person picking station M5-M8, the persons performing the picking K5-K8 can also process several picking orders in parallel. The picking software is designed such that the section of the central belt which is filled with the products continues to move to the transfer station at a uniform speed and arrives there simultaneously with the order transport unit B allocated to the picking order so that the products can immediately be transferred from the section of the central belt into the order transport unit.

Upstream of the manual goods-to-person picking stations M5-M8, the two central belts ZB3, ZB4 move past the automated picking systems A3, A4, which transfer fast moving products onto the central belts ZB3, ZB4 according to picking orders, wherein certain sections of the central belts ZB3, ZB4 are allocated to the picking orders by the higher-ranking picking software, onto which sections the automatons A3, A4 will then transfer the products allocated to those picking orders in the stipulated number of pieces—which is controlled by the picking software. These products are also transferred at the transfer stations Ü3, Ü4 in order transport units B allocated to the picking orders. FIG. 4 shows a schematic flow chart of the paths of the order transport units and of the products on the lower picking level E1. After the order transport units B have passed through the transfer stations Ü3, Ü4, they reach the order end position FIN on the lower main hauling track 22. This order end position FIN may, for example, be a shipping area or another subsequent processing station, but also a station for channelling into the conveyor system 2, by means of which order transport units containing products from picking orders which have been settled only partially are returned to the high racks HR1-HR3 (or optionally also the fast access storage FB) and are stored temporarily until, at the order starting position STA, they are returned into a picking cycle in order to process the associated picking order further or completely.

FIG. 5 shows a schematic diagram of the paths of the products P and the source containers Q, respectively, in the picking system 1 during the retrieval from the high racks HR1, HR2, HR3 and from the fast access storage FB and the supply to the manual goods-to-person picking stations, with the retrieval paths being illustrated by black arrows. Said diagram has equal validity for the upper and the lower picking levels E2, E1. For the sake of better clarity, only the manual goods-to-person picking stations M1 and M3 of the upper picking level E2 and, respectively, the manual goods-to-person picking stations M7 and M5 which are locally situated beneath the former are illustrated. The dashed arrows symbolize the return paths of the products P and the source containers Q, respectively, to the high racks HR1, HR2, HR3 and the fast access storage FB.

FIG. 6 shows a schematic diagram of the paths of the products P and the source containers Q, respectively, in the picking system 1 during the return from the manual goods-to-person picking stations to the high racks HR1-HR3 or the fast access storage FB, respectively. Those return paths are marked by black arrows. Said diagram has equal validity for the upper and the lower picking levels E2, E1. For the sake of better clarity, only the manual goods-to-person picking stations M1 and M3 of the upper picking level E2 and, respectively, the manual goods-to-person picking stations M7 and M5 which are locally situated beneath the former are illustrated. The dashed arrows symbolize the paths of the products P and the source containers Q, respectively, from the high racks HR1, HR2, HR3 and the fast access storage FB toward the manual goods-to-person picking stations M1, M3, M5, M7.

FIG. 7 shows a schematic diagram of the entire product flow between the high racks HR1-HR3, the fast access storage FB and the manual goods-to-person picking stations (not illustrated) in the picking system 2.

As can be seen from the previous description, the picking system 1 according to the invention works such that all products P of the high-bay racking R which are to be picked manually can be supplied to all goods-to-person picking stations M1-M8 by means of the conveyor system 2. A control is provided (picking software running on computers) which, if a picking order includes products to be picked manually, allocates at least one order transport unit B to those products to be picked manually and controls the conveyor system such that each order transport unit is supplied to only one manual goods-to-person picking station at which all products to be picked manually which have been allocated to this order transport unit are picked manually in the stipulated number of pieces. The respective order transport unit is transported to the manual goods-to-person picking station only when said picking station is ready to settle a picking order. A picking order is also understood to be a part of a picking order or a multi-part picking order. For example, a first purchase order for medicaments is placed by a pharmacy with a wholesale pharmaceutical store at 9 a.m. and a second purchase order is placed at 11 a.m. Both purchase orders are to be delivered together at 1 p.m. In the wholesale pharmaceutical store, the first purchase order is registered as a picking order and is settled immediately or any time before 1 p.m. depending on the job load, and the order transport unit is then stored temporarily until the delivery at 1 p.m. When the second purchase order is received at 11 a.m., the order transport unit which has already been filled with the products of the first picking order is sent into a further picking cycle in order to process also the second picking order and to deliver both purchase orders together at 1 p.m. In this way, the wholesale pharmaceutical store can achieve a more uniform distribution of the picking load, for example, by offering discounts for early purchase orders to the pharmacies, at the same, however, the time slot for last-minute purchase orders can be kept open for a long time.

FIG. 8 shows a perspective view of a preferred embodiment of the fast access storage FB which is used advantageously for the invention and in which fast moving products can be stored temporarily and supplied to the manual goods-to-person picking stations M1-M8 via the conveyor system 2. The fast access storage FB comprises a lift 6 on which platforms 7 are arranged on top of each other in several storage levels in which products P and source containers Q, respectively, and optionally order transport units B can be stored and, respectively, retrieved from, storage. The platforms 7 and the lift 6 comprise drive elements, e.g., motor rollers 8, by means of which products and source containers Q, respectively, in which the products are placed, and optionally order transport units B are moved actively. The platforms 7 are built with such a depth that they accomodate at least two products P or source containers Q behind each other per platform, wherein preferably a type-sorted storage of products is carried out per platform.

1. A method of picking products (P) stored in high-bay racking (R), wherein a storage transport system (LT) for storing the products (P) and retrieving them from storage and for transferring products (P) retrieved from storage to a conveyor system (2) is allocated to the high-bay racking, by means of which conveyor system products (P) retrieved from storage can be transported to one or several, preferably at least two, manual goods-to-person picking stations (M1-M8), wherein order transport units (B), such as, e.g., order containers, trays, pallets, can be supplied to the goods-to-person picking stations (M1-M8), into which order transport units products supplied to the goods-to-person picking stations (M1-M8) are picked manually according to picking orders and in the number of pieces specified in the picking orders,
characterized in that
all products (P) of the high-bay racking (R) which are to be picked manually can be supplied to all goods-to-person picking stations (M1-M8),
if a picking order includes products (P) to be picked manually, at least one order transport unit (B) is allocated to those products to be picked manually, wherein each order transport unit is supplied to only one manual goods-to-person picking station (M1-M8) at which all products to be picked manually which have been allocated to this order transport unit are picked manually in the stipulated number of pieces, wherein the respective order transport unit (B) is transported to the manual goods-to-person picking station (M1 -M8) only when said picking station is ready to be filled with products (P) according to a picking order.

2. A picking method according to claim 1, characterized in that products supplied to the manual goods-to-person picking station (M1-M4) are transferred manually directly into the order transport unit.

3. A picking method according to claim 1, characterized in that the manual goods-to-person picking stations (M5-M8) are equipped with buffer containers (4), particularly buffer bowls, into which products to be picked are transferred manually, before an order transport unit allocated to those products is transported to the picking station (M5-M8), wherein the buffer containers are emptied out onto a central belt (ZB3, ZB4), which empties the products into the order transport unit (B) downstream at a transfer station (Ü3, Ü4), or are emptied out directly into the order transport unit.

4. A picking method according to claim 3, characterized in that, at the manual goods-to-person picking station (M5-M8), equal products which are included in several picking orders are picked into different buffer bowls (4) allocated to the different picking orders in a parallel processing of the picking orders.

5. A picking method according to claim 1, characterized in that each order transport unit (B), before or after it is filled at the manual goods-to-person picking station allocated to it with the products of a picking order which are to be picked manually, is transported to at least one automated picking system (A1-A4), where it is filled with products of the picking order allocated to it which can be picked automatically or semi-automatically, and/or is transported to a transfer area (Ü1-Ü4) of a central belt (ZB1-ZB4), where the order transport unit is filled with products located on a belt section allocated to said picking order, which products have upstream been picked automatically or semi-automatically onto said belt section.

6. A picking method according to claim 1, characterized in that the conveyor system (2) is attached to a fast access storage (FB), in which fast moving products are stored temporarily, which are supplied to the manual goods-to-person picking stations (M1-M8) via the conveyor system.

7. A picking method according to claim 1, characterized in that order transport units (B) which contain products from partially processed picking orders are stored temporarily in the high-bay racking (R) until the picking order continues to be processed.

8. A picking system (1) for products (P) stored in high-bay racking (R), comprising:
a storage transport system (LT) for storing the products (P) in the high-bay racking and retrieving them from the high-bay racking;
a conveyor system (2) onto which products (P) retrieved from store and onto the storage transport system can be transferred;
one or several, preferably at least two, manual goods-to-person picking stations (M1-M8) to which products (P) retrieved from storage can be transported by the conveyor system (2);
wherein, by means of the conveyor system (2), order transport units (B), such as, e.g., order containers, trays, pallets, can be supplied to the goods-to-person picking stations (M1-M8) and can be transported from the goods-to-person picking stations (M1-M8) to an order end position (FIN), in particular a subsequent processing station, such as a shipping area or a temporary storage facility;
wherein products supplied to the goods-to-person picking stations (M1-M8) can be picked manually according to picking orders in the number of pieces specified in the picking orders;
characterized in that
all products of the high-bay racking which are to be picked manually can be supplied to all goods-to-person picking stations (M1-M8) via the conveyor system (2),
a control is provided which, if a picking order includes products to be picked manually, allocates at least one order transport unit (B) to those products to be picked manually and controls the conveyor system (2) such that each order transport unit is supplied to only one manual goods-to-person picking station (M1-M8) at which all products to be picked manually which have been allocated to this order transport unit are picked manually in the stipulated number of pieces, wherein the respective order transport unit is transported to the manual goods-to-person picking station (M1-M8) only when said picking station is ready to process a picking order.

9. A picking system according to claim 8, characterized in that the manual goods-to-person picking stations (M1-M4) are designed for the direct manual transfer of supplied products into the order transport unit.

10. A picking system according to claim 8, characterized in that the manual goods-to-person picking stations (M5-M8) are equipped with buffer containers (4), particularly buffer bowls, with the buffer containers comprising means (5) such as flaps, chutes etc. for emptying products from the buffer containers onto a central belt (ZB3, ZB4), which empties the products into the associated order transport units (B) downstream at a transfer station (Ü3, Ü4), or for direct emptying into the order transport units.

11. A picking system according to claim 8, characterized by automated picking systems (A1-A4) arranged at the transport path of the order transport units, wherein the automated picking systems transfer products automatically to the order transport units, according to picking orders.

12. A picking system according to claim 8, characterized by at least one central belt (ZB1-ZB4) with a transfer station (Ü1-Ü4) at which the order transport unit (B) can be filled with products which have upstream been picked onto a section of the central belt which has been allocated to a picking order.

13. A picking system according to claim 8, characterized by a fast access storage (FB) which is attached to the conveyor system (2) and in which fast moving products can be stored temporarily and supplied to the manual goods-to-person picking stations (M1-M8) via the conveyor system (2).

14. A picking system according to claim 13, characterized in that the fast access storage (FB) comprises at least one lift (6) on which platforms (7) are arranged on top of each other in several storage levels, in which products and optionally order transport units can be stored and, respectively, retrieved from storage.

15. A picking system according to claim 14, characterized in that the platforms (7) and the lift (6) comprise drive elements, e.g., motor rollers (8), by means of which products and source containers (Q), respectively, in which the products (P) are placed, and optionally order transport units (B) are moved actively.

16. A picking system according to claim 14, characterized in that the platforms (7) are built with such a depth that each platform accommodates at least two products or source containers behind each other, wherein preferably a type-sorted storage of products is carried out per platform.

17. A picking system according to claim 8, characterized in that order transport units (B) which contain products from partially processed picking orders can be supplied to the high-bay racking (R) and/or the fast access storage (FB) by means of the conveyor system (2) until the picking order continues to be processed.
